(19) United States
(12) Patent Application Publication
(10) Pub. No.: US 2010/0130655 A1
(43) Pub. Date: May 27, 2010

(54) CURABLE EPOXY RESIN-BASED ADHESIVE COMPOSITIONS

(75) Inventors: Rajat K. Agarwal, Duesseldorf (DE); Olaf Lammerschop, Danville, CT (US); Barry N. Burns, Killiney (IE)

Correspondence Address: Loctite Corporation, One Henkel Way, Rocky Hill, CT, 06067, US

(73) Assignees: Henkel Corporation, Rocky Hill, CT (US); Loctite (R&D) Limited, Dublin (IE)

(21) Appl. No.: 12/692,765

(22) Filed: Jan. 25, 2010

Related U.S. Application Data
(63) Continuation of application No. PCT/US2008/009076, filed on Jul. 25, 2008.
(60) Provisional application No. 60/952,048, filed on Jul. 26, 2007.

(51) Int. Cl. C08K 5/521; C08K 5/42; C08G 77/04; C08L 63/00; C08G 71/04

(52) U.S. Cl. 524/145; 524/157; 524/500; 525/122; 525/453; 525/476; 525/510; 525/523

(57) ABSTRACT

This invention relates to compositions useful as adhesives and more particularly to epoxy-based adhesive compositions with improved impact resistance.

### CROSS REFERENCE TO RELATED APPLICATIONS

This application is a continuation under 35 U.S.C. Sections 365(c) and 120 of International Patent Application No. PCT/US2008/009076, filed Jul. 25, 2008 and published on Feb. 5, 2009 as WO 2009/017690, which claims priority from U.S. Provisional Patent Application No. 60/952,048 filed Jul. 26, 2007, which are incorporated herein by reference in their entirety.

### BACKGROUND OF THE INVENTION

1. Field of the Invention

This invention relates to compositions useful as adhesives and more particularly to epoxy-based adhesive compositions with improved impact resistance.

2. Brief Discussion of Related Technology

Numerous compositions and processes are described in the art for making and using a wide variety of epoxy-based compositions and other resins and additives in an effort to improve the expansion, impact resistance and other key properties of adhesives useful in adhering, filling and making composite structures. For example, components for the formulation of adhesive compositions and the use of such compositions to adhere various substrates to each other and to provide structural reinforcement are described in for instance U.S. Pat. Nos. 5,290,857, 5,686,509, 5,334,654, 6,015,865, 5,278,257, 6,884,854, and 6,776,869 and U.S. Patent Application Publication No. 2005-0022929.

For advanced structural adhesive operations such as vehicle assembly, adhesives are required which provide broad cure schedules, stiffness improvement, weld reduction and energy/management. In particular, it would be highly desirable to develop heat-curable structural adhesives that not only have these characteristics but also are capable of forming strong bonds to metal surfaces contaminated with oily substances (especially surfaces comprised of cold rolled steel, which has the advantage of being significantly less expensive than other types of metals that could be used in vehicle construction).

In particular, it is known that the use of core-shell rubber particles that are stably dispersed in an epoxy resin matrix and that are nano-sized (e.g., about 25 to about 200 nm) are capable of improving the impact properties of epoxy-based adhesives.

### SUMMARY OF THE INVENTION

The present invention broadly speaking provides adhesive formulations having an epoxy resin component, rubber particles (particularly those characterized by the absence of a shell), at least one additive selected from polyurethanes, platy fillers, or anti-oxidants, and at least one latent curing agent capable of being activated by heating. Optionally at least one diluent (e.g., sulfonate diluents, phosphate ester diluents) may also be included. Optionally, such compositions may also contain chelate-modified epoxy resin, auxiliary impact modifiers/toughening agents, fillers other than mica (e.g., calcium oxide), thixotropic agents (e.g., fumed silica, mixed mineral thixotropes), or other adjuvants. When applied to a substrate or carrier and cured by heating, the adhesive results in a product capable of forming strong bonds to oil-contaminated metal surfaces while simultaneously exhibiting good impact toughness and/or impact resistance.

### DETAILED DESCRIPTION OF THE INVENTION

In one embodiment of the invention, the adhesive composition is comprised of at least one epoxy resin (especially a diglycidyl ether of a polyphenol such as bisphenol A), at least one type of rubber particles (particularly those characterized by the absence of a shell), at least one polyurethane (especially a reaction product of an isocyanate-terminated prepolymer and a compound having one or more phenolic, benzyl alcohol, aminophenyl or benzylamino groups, as described for example in U.S. Pat. No. 5,278,257), at least one epoxy-based prepolymer obtained by reacting one or more amine-terminated polymers such as an amine-terminated polyether with one or more epoxy resins, and at least one heat-activated latent curing agent.

In another embodiment of the invention, the adhesive composition is comprised of at least one epoxy resin (especially a diglycidyl ether of a polyphenol such as bisphenol A), at least one type of rubber particles (particularly those characterized by the absence of a shell), at least one epoxy-based prepolymer obtained by reacting one or more amine-terminated polymers such as an amine-terminated polyether with one or more epoxy resins, mica, at least one anti-oxidant (especially a hindered phenol anti-oxidant) and at least one heat-activated latent curing agent.

In still another embodiment of the invention, the adhesive composition is comprised of at least one epoxy resin (especially a diglycidyl ether of a polyphenol such as bisphenol A), at least one type of rubber particles (particularly those characterized by the absence of a shell), at least one polyurethane (especially an acrylate-functionalized polyurethane), at least one epoxy-based prepolymer obtained by reacting one or more amine-terminated polymers such as an amine-terminated polyether with one or more epoxy resins, at least one anti-oxidant (especially a hindered phenol anti-oxidant) and at least one heat-activated latent curing agent.

In still another embodiment of the invention, the adhesive composition is comprised of A) at least one epoxy resin; B) rubber particles; C) at least one additive selected from polyurethanes, platy fillers, and anti-oxidants; and D) at least one heat-activated latent curing agent. Desirably, the rubber particles have an average particle size of less than 500 nm, such as an average particle size of less than about 250 nm. And desirably the rubber particles are surface treated, so as to increase the crosslink density and permit the formation of a stable dispersion in a diluent, for instance. The composition may also include an auxiliary impact modifier/toughening agent, a chelate-modified epoxy resin, and a diluent (such as a reactive of non-reactive one).

### Epoxy Resins

In general, a large number of polyepoxides having at least about two 1,2-epoxy groups per molecule are suitable as epoxy resins for the compositions of this invention. The polyepoxides may be saturated, unsaturated, cyclic or acyclic, aliphatic, alicyclic, aromatic or heterocyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefor are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane, and 1,5-hydroxynaphthalene. Other suitable polyphenols as the basis for the polyglycidyl ethers are the known condensation products of phenol and formaldehyde or acetaldehyde of the novolak resin-type.

Other polyepoxides that are in principle suitable are the polyglycidyl ethers of polyalcohols or diamines. Such polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or a dimeric fatty acid. Other epoxides are derived from the epoxidation products of olefinically-unsaturated cycloaliphatic compounds or from natural oils and fats.

The epoxy resins useful herein may be in the solid, semi-solid or liquid state.

Particular preference is given to the liquid epoxy resins derived by reaction of bisphenol A or bisphenol F and epichlorohydrin. The epoxy resins that are liquid at room temperature generally have epoxy equivalent weights of from 150 to about 480.

The epoxy resins that are solid at room temperature may also or alternatively be used and are likewise obtainable from polyphenols and epichlorohydrin; particular preference is given to those based on bisphenol A or bisphenol F having a melting point of from 45 to 130° C., preferably from 50 to 80° C. They differ from the liquid epoxy resins substantially by the higher molecular weight thereof, as a result of which they become solid at room temperature. The solid epoxy resins generally have an epoxy equivalent weight of ≧400.

Typically, the composition may contain from about 25 to about 55 weight percent (in one embodiment, from about 30 to about 50 weight percent) of epoxy resin.

### Rubber Particles

Rubber particles, especially rubber particles that have relatively small average particle size (e.g., less than about 500 nm or less than about 200 nm), are an additional component of the compositions of the present invention. The rubber particles do not have the shell of known core-shell structures. Rather the rubber particles may be based on the core of such structures.

Preferably, the rubber particles are relatively small in size. For example, the average particle size may be from about 0.03 to about 2μ or from about 0.05 to about 1μ. In certain embodiments of the invention, the rubber particles have an average diameter of less than about 500 nm. In other embodiments, the average particle size is less than about 200 nm. For example, the rubber particles may have an average diameter within the range of from about 25 to about 200 nm or from about 50 to about 150 nm.

The rubber particles generally are comprised of a polymeric material having elastomeric or rubbery properties (i.e., a glass transition temperature less than about 0° C., e.g., less than about −30° C.). For example, the rubber particles may be comprised of a diene homopolymer or copolymer (for example, a homopolymer of butadiene or isoprene, a copolymer of butadiene or isoprene with one or more ethylenically unsaturated monomers such as vinyl aromatic monomers, (meth)acrylonitrile, (meth)acrylates, or the like) and polysiloxanes. The rubber particles may contain functional groups such as carboxylate groups, hydroxyl groups or the like and may have a linear, branched, crosslinked, random copolymer or block copolymer structure.

For instance, the rubber particles may be formed predominantly from feed stocks of dienes such as butadiene, (meth)acrylates, ethylenically unsaturated nitriles such as acrylonitrile, and/or any other monomers that when polymerized or copolymerized yield a polymer or copolymer having a low glass transition temperature.

The rubber particles may be used in a dry form or may be dispersed in a matrix, such as an epoxy matrix or a phenolic matrix. The matrix material preferably is liquid at room temperature. Examples of epoxy matrices include the diglycidyl ethers of bisphenol A, F or S, or bisphenol, novalac epoxies, and cycloaliphatic epoxies. Examples of phenolic resins include bisphenol-A based phenoxies.

The rubber particles may be present in the epoxy or phenolic matrix in an amount in the range of about 5 to about 50 weight percent (about 15 to about 40 weight percent).

Typically, the composition may contain from about 5 to about 35 weight percent (in one embodiment, from about 15 to about 30 weight percent) rubber particles.

Combinations of different rubber particles may advantageously be used in the present invention. The rubber particles may differ, for example, in particle size, the glass transition temperatures of their respective materials, whether, to what extent and by what the materials are functionalized, and whether and how their surfaces are treated.

A portion of the rubber particles may be supplied to the adhesive composition in the form of a masterbatch wherein the particles are stably dispersed in an epoxy resin matrix and another portion may be supplied to the adhesive composition in the form of a dry powder (i.e., without any epoxy resin or other matrix material). For example, the adhesive composition may be prepared using both a first type of rubber particles in dry powder form having an average particle diameter of from about 0.1 to about 0.5μ and a second type of rubber particles stably dispersed in a matrix of liquid bisphenol A diglycidyl ether at a concentration of from about 5 to about 50 percent by weight having an average particle diameter of from about 25 to about 200 nm. The weight ratio of first type:second type rubber particles may be from about 1.5:1 to about 0.3:1, for example.

The chemical composition of the rubber particles may be essentially uniform throughout each particle. However, the outer surface of the particle may be modified by reaction with a coupling agent, oxidizing agent or the like so as to enhance the ability to disperse the rubber particles in the adhesive composition (e.g., reduce agglomeration of the rubber particles, reduce the tendency of the rubber particles to settle out of the adhesive composition). Modification of the rubber particle surface may also enhance the adhesion of the epoxy resin matrix to the rubber particles when the adhesive is cured. The rubber particles may alternatively be irradiated so as to change the extent of crosslinking of the polymer(s) constituting the rubber particles in different regions of the particle. For example, the rubber particles may be treated with gamma radiation such that the rubber is more highly crosslinked near the surface of the particle than in the center of the particle.

Rubber particles that are suitable for use in the present invention are available from commercial sources. For example, the following rubber particles supplied by Eliokem, Inc. may be used: NEP R0401 and NEP R401S (both based on acrylonitrile/butadiene copolymer); NEP R0501 (based on carboxylated acrylonitrile/butadiene copolymer; CAS 9010-81-5); NEP R0601A (based on hydroxy-terminated polydimethylsiloxane; CAS 70131-67-8); and NEP R0701 and NEP 0701S (based on butadiene/styrene/2-vinylpyridine copolymer; CAS 25053-48-9). The foregoing materials are believed to contain minor amounts of inorganic materials such as calcium carbonate or silica.

Rubber particles that have been treated with a reactive gas or other reagent to modify the outer surfaces of the particles by, for instance, creating polar groups (e.g., hydroxyl groups, carboxylic acid groups) on the particle surface, are also suitable for use in the present invention. Illustrative reactive gases include, for example, ozone, Cl₂, F₂, O₂, SO₃, and oxidative gases. Methods of surface modifying rubber particles using such reagents are known in the art and are described, for example, in U.S. Pat. Nos. 5,382,635; 5,506,283; 5,693,714; and 5,969,053, each of which is incorporated herein by reference in its entirety. Suitable surface modified rubber particles are also available from commercial sources, such as the rubbers sold under the tradename VISTAMER by Exousia Corporation.

Where the rubber particles are initially provided in dry form, it may be advantageous to ensure that such particles are well dispersed in the adhesive composition prior to curing the adhesive composition. That is, agglomerates of the rubber particles are preferably broken up so as to provide discrete individual rubber particles, which may be accomplished by intimate and thorough mixing of the dry rubber particles with other components of the adhesive composition. For example, dry rubber particles may be blended with epoxy resin and milled or melt compounded for a length of time effective to essentially completely disperse the rubber particles and break up any agglomerations of the rubber particles.

Typically, in embodiments of this invention where the adhesive composition contains rubber particles and/or auxiliary impact modifier/toughening agent(s), the weight ratio of epoxy resin: combined weight of auxiliary impact modifier/toughening agent (e.g., epoxy-based prepolymer) and rubber particles from about 0.25:1 to about 2.5:1 or from about 0.5:1 to about 1.5:1.

In embodiments of the present invention wherein the adhesive composition contains both rubber particles and one or more auxiliary impact modifiers/toughening agents, the weight ratio of auxiliary impact modifier/toughening agent (e.g., epoxy-based prepolymer): rubber particles is typically from about 3:1 to about 0.2:1 or from about 2:1 to about 0.5:1.

### Polyurethanes

In accordance with one aspect of this invention, the adhesive composition contains one or more polyurethanes. The polyurethane may be any oligomeric or polymeric substance containing a plurality of urethane and/or urea linkages and one or more “soft” (elastomeric) segments having a glass transition temperature less than room temperature (e.g., less than about 0° C., less than about −20° C., or less than about −40° C.). The urethane and urea linkages are typically formed by reaction of an active hydrogen-containing material such as a polyol (e.g., polyether polyol, polyester polyol, monomeric polyalcohol, or polybutadiene polyol) or polyamine with an isocyanate (in particular, compounds containing two or more isocyanate groups per molecule). In certain embodiments of the present invention, the polyurethane selected for used is an isocyanate-functionalized polyurethane prepolymer in which at least a portion of the isocyanate groups have been reacted or blocked. The isocyanate groups of the prepolymer may be blocked or reacted with any suitable reactant such as an alcohol (e.g., a phenol), oxime, amine, lactam (e.g., caprolactam), acetoacetate, malonate or the like. In one embodiment of the invention, the blocking groups remain on the polyurethane prepolymer when the adhesive composition is cured, but in other embodiments “de-blocking” takes place such that the polyurethane prepolymer is capable of reacting with other components of the adhesive composition when the composition is cured.

For example, the polyurethane may be a acrylate-functionalized polyurethane such as those described in U.S. Pat. Nos. 3,297,745; 4,360,653; 4,390,662; 4,719,268; 4,486,582; 4,618,658; 5,334,654; and 5,700,891 which are hereby incorporated by reference in their entirety. (Meth)acrylate-functionalized polyurethanes may comprise the reaction product of an isocyanate-terminated urethane prepolymer and an isocyanate-reactive acrylate and/or methacrylate. Isocyanate terminated prepolymers are prepared by reacting a polyfunctional isocyanate, typically an aromatic diisocyanate, with a polyol, preferably a long chain hydroxyl-terminated polyether or polyester polyol, such as the ethylene and propylene oxide adducts of C₂ to C₄ polyalcohols, polytetramethylene glycol (“polyTHF”), and polycaprolactone. For enhanced flexibilization of the cured adhesive, the molecular number average weight of the polyol should range from about 400 to 4000, preferably 700 to 2000. Acrylate terminated urethane resins utilizing a polyol having a number average molecular weight of less than 1000 generally are extremely viscous. Higher molecular weight polyols tend to cause premature phase separation in the formulated adhesive leading to poor physical properties. The preferred isocyanate-terminated urethane prepolymer is prepared by any known means, for example, a 2000 mw polypropylene glycol may be reacted with an 80/20 2,4/2,6-toluenediisocyanate mixture. Any other polyisocyanate such as methylenediphenyldiisocyanate (“MDI”), isophoronediisocyanate (“IPDI”), or paraphenylenediisocyanate (“PPDI”) is also suitable.

The acrylates and methacrylates (collectively “(meth)acrylates”) typically used to prepare the (meth)acrylate-functionalized polyurethanes are hydroxy alkylacrylates and methacrylates and these include: hydroxyacrylates such as hydroxyethyl acrylate or methacrylate, hydroxypropyl acrylate or methacrylate, hydroxypentyl acrylate or methacrylate, 2-hydroxyethyl acrylate, 2-hydroxyethyl hexyl methacrylate, hydroxybutyl methacrylate and the like. Typically the ester portion of the acrylate or methacrylate is from a C₂-C₈ alcohol. Mixtures of different (meth)acrylates may be used.

Additional materials which can be used to prepare substances which we choose to describe as included within the definition of (meth)acrylate-functionalized polyurethanes include the following:

prepolymers having number average molecular weights of 250-10,000, preferably 700-4000, and having glass transition temperatures below about 10° C., preferably below about −10° C. The average functionality of these prepolymers is at least 2, preferably 2 to 6 and particularly preferably 2 to 3. The terminal functional groups of the prepolymer are isocyanate-reactive and may be amino or hydroxyl or carboxyl or mercapto, preferably, hydroxyl. Particularly preferred prepolymers include linear and branched polypropylene glycols having number average molecular weights about 700 to about 4000; linear and branched polytetrahydrofurans having number average molecular weights between about 700 and about 4000; linear and branched poly(1,2-buyleneoxide) having number average molecular weights between about 700 and about 4000; and hydroxyl-terminated polyesters having number average molecular weights between about 700 and about 4000;
polyisocyanates, preferably diisocyanates or triisocyanates such as isophonoronediisocyanate, methylenediphenyldiisocyanate, toluenediisocyanate, hexamethylenediisocyanate, tetramethylxyl)-lenediisocyanate, and the like; and isocyanate-reactive acrylates or methacrylates, preferably hydroxyacrylates or methacrylates such as hydroxyethylacrylate, hydroxypropylacrylate, hydroxyethylmethacrylate, hydroxypropylmethacrylate, and the like.

Chain lengtheners such as diols and triols like 1,4 butanediol, 1,1,1-trimethylolpropane, glycerol, 1,2,6-hexanetriol, pentaerythritol and the like optionally may be employed in combination with the polyol(s), preferably, from 0.01 to about 5% by weight. When triol chain lengtheners, as described above, are added during this reaction and a suitable amount of polyisocyanate is used, branched NCO-tipped prepolymers are produced. Diol chain lengtheners can be used to control the molecular weight of the resulting prepolymer. This NCO-functional polymer is then reacted with the NCO-reactive acrylate or methacrylate to yield materials which are described for the purposes of this invention as (meth)acrylate-functionalized polyurethanes.

(Meth)acrylate-functionalized polyurethanes are also available from commercial sources such as, for example, the acrylate-functionalized polyurethanes sold under the tradename ANCAREZ by Air Products.

Polyurethanes suitable for use in the adhesive compositions of the present invention include the reaction products of isocyanate-terminated prepolymers and compounds having one or more active hydrogen-containing groups (e.g., hydroxyl, thiol and amino groups such as primary aliphatic, cycloaliphatic, heteroaromatic and araliphatic amino, secondary aliphatic, cycloaliphatic, heteroaromatic and araliphatic amino, alkyl amido, phenolic, benzyl alcohol, aminophenyl or benzylamino groups or the like, such as those described in U.S. Pat. Nos. 3,525,779; 3,636,133; 5,278,257; and 6,776,869; U.S. Patent Application Publication No. US 2005/070634, and International Patent Publication No. WO 2006/128722, each of which is incorporated herein by reference in its entirety). Such polyurethanes may or may not contain isocyanate-reactive end groups (e.g., active hydrogen-containing end groups). Polyurethanes of this type are also available commercially from Huntsman Advanced Materials (formerly Vantico) under the tradename RAM.

Also suitable for use as polyurethanes in the present invention are branched aromatic urethane polymers containing ether groups, such as the products sold under the tradenames DESMOCAP 11A and DESMOCAP 12A by Bayer Material Science (which have been described as 4-nonylphenol blocked isocyanate prepolymers or polypropyleneglycol/toluene diisocyanate prepolymers blocked with 4-nonylphenol).

The polyurethane may also be an epoxy-functionalized polyurethane of the type disclosed in International Patent Publication Nos. US 2007/0066721 and US 2007/0105983, each of which is incorporated herein by reference in its entirety. Such epoxy-functionalized polyurethanes may, for example, be prepared by reacting an isocyanate-functionalized polyurethane prepolymer with a hydroxy-functionalized glycidyl ether.

In general, the adhesive compositions of the present invention may contain up to about 20 weight % (e.g., about 0.1 to about 10 or about 2 to about 8 weight %) of polyurethane.

### Anti-Oxidants

In certain embodiments of the invention, the adhesive composition additionally contains one or more anti-oxidants. Particularly suitable anti-oxidants for purposes of this invention include phenolic (especially hindered phenolic) anti-oxidants such as, for example, the alkylated reaction products of phenols and dienes, such as the butylated reaction product of p-cresol and dicyclopentadiene sold by Eliokem under the tradename WINGSTAY L, and well as stearyl 3-(3,5-di-tert-butyl-4-hydroxyphenyl)propionate (sold under the tradename ANTIOXIDANT 1076 by Akrochem Corp.).

Typically, the anti-oxidant(s) may be present in the adhesive composition at concentrations up to about 3 weight percent (e.g., from about 0.1 to about 2 weight %).

### Platy Fillers

In certain embodiments of the invention, the adhesive composition additionally contains one or more platy fillers such as mica, glass flakes, metal flakes, delaminated graphite, talc or clay (e.g., kaolin). Preferably, the mica is muscovite mica such as 4K mica in powder or ground form. The mica particles may, for example, have a relatively high aspect ratio (e.g., from about 5 to about 15), a bulk density of from about 10 to about 20 lb/ft³, and/or a median particle diameter [D (V, 0.5), the size value of particles at which 50% of the sample is smaller and 50% is larger than this value, also known as the mass median diameter] of from about 10 to about 100 microns. Typically, the composition may contain up to about 10 weight percent (e.g., from about 0.1 to about 3 weight percent) platy filler. The surface of the platy filler may optionally be treated, for example, by reaction with a coupling agent such as a silane.

### Auxiliary Impact Modifiers/Toughening Agents

The impact properties of cured adhesive compositions in accordance with the present invention can be further improved or modified by the incorporation of one or more auxiliary impact modifiers and/or toughening agents. In one embodiment, the auxiliary impact modifier/toughening agent contains one or more functional groups capable of participating in the reaction of the epoxy resin component when the adhesive composition is cured. Suitable reactive functional groups include epoxy groups, carboxylic acid groups, and the like.

The epoxy-based prepolymers (sometimes described herein as “adducts”) obtained by reacting one or more amine-terminated polymers such as amine-terminated polyethers or amino silane capped polymers with one or more epoxy resins represent a particularly preferred class of auxiliary impact modifiers/toughening agents. The epoxy resins useful for such purpose may be selected from among the epoxy resins described hereinabove, with particular preference being given to the diglycidyl ethers of polyphenols such as bisphenol A and bisphenol F (for example, having epoxy equivalent weights of from about 150 to about 1000). Mixtures of solid and liquid epoxy resins may be suitably employed.

The preparation of such epoxy-based prepolymers from amine-terminated polyethers is well known in the art and is described, for example, in U.S. Pat. Nos. 5,084,532 and 6,015,865, each of which is incorporated herein by reference in its entirety. Generally speaking, it will often be desirable to adjust the ratio of amine-terminated polyether:epoxy resin being reacted such that there is an excess of epoxy groups relative to amine groups such that the latter functional groups are completely reacted (i.e., the epoxy-based prepolymer contains essentially no free amine groups).

In the preparation of the epoxy-based prepolymer, the following compounds may, for example, be used:

1. linear amine-terminated polyoxyethylene ethers having the formula:

H₂N—(CH₂)₂—[O—(CH₂)₂—O—(CH₂)₂]ₙ—NH₂

in which n preferably is 17 to 27.
2. linear amine-terminated polyoxypropylene ethers having the formula:

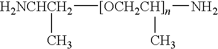

in which n preferably is 5 to 100. They are obtainable from Huntsman Chemical under the trade name JEFFAMINE® (D-series). The number average molecular weight of such amine-terminated polyoxypropylene ethers may vary, for example, from about 300 to about 5000.
3. trifunctional compounds having the formula:

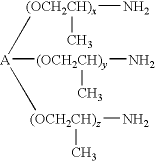

in which A is

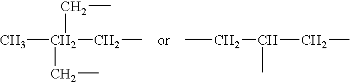

and x, y and z independently of each other are 1 to 40 and x+y+z is preferably >6. Representative examples of these trifunctional compounds are available commercially from Huntsman Chemical under the tradename JEFFAMINE® (T-series). Such substances typically have number average molecular weights of from about 300 to about 6000.
4. amino silane capped polymers, such as those that may be embraced by the general formula:

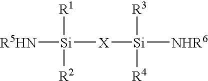

where R¹, R², R³ and R⁴ may be the same or different and are selected from hydrogen, hydroxyl, alkyl, alkoxy, alkenyl, alkenyloxy, aryl, and aryloxy; R⁵ and R⁶ may be the same or different and are selected from hydrogen, alkyl and aryl; and X is selected from alkylene, alkenylene, arylene, with or without interruption by a heteroatom; polyurethanes; polyethers; polyesters; polyacrylates; polyamides; polydienes; polysiloxanes; and polyimides.

For instance, amine-terminated siloxanes may be used, such as diamino siloxanes embraced by:

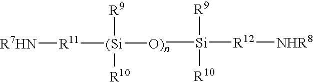

where R¹¹ and R¹² may be the same or different and are selected from alkylene, arylene, alkylene oxide, arylene oxide, alkylene esters, arlyene esters, alkylene amides or arylene amides; R⁹ and R¹⁰ may be the same or different and are selected from alkyl or aryl; R⁷ and R⁸ are as defined above and n is 1-1,200.

Certain amino-modified silicone fluids that are commercially available from Shin-Etsu under the trade designations KF857, KF858, KF859, KF861, KF864 and KF880 may be useful herein. In addition, Wacker Silicones offers commercially a line of amino-functional silicone fluids designated as L650, L651, L653, L654, L655 and L656, and an amino-functional polydimethylsiloxane under the tradename WACKER FINISH WR 1600 that may be useful herein.

Other amino-functionalized silanes or siloxanes useful in forming the adduct include materials available for purchase from Degussa's Sivento division, such as a proprietary aminofunctional silane composition (called DYNASYLAN® 1126), an oligomeric diaminosilane system (called DYNASYLAN® 1146), N-vinylbenzyl-N′-aminoethyl-e-aminopropylpolysiloxane (DYNASYLAN® 1175), N-(n-butyl)-3-aminopropyltrimethoxysilane (DYNASYLAN® 1189), a proprietary aminofunctional silane composition (called DYNASYLAN® 1204), N-(2-aminoethyl)-3-aminopropylmethyldimethoxysilane (DYNASYLAN® 1411), 3-aminopropylmthyldiethoxysilane (DYNASYLAN® 1505), 3-aminopropylmethyldiethoxysilane (DYNASYLAN® 1506), 3-aminopropyltriethoxysilane (DYNASYLAN® AMEO), a proprietary aminosilane composition (called DYNASYLAN® AMEO-T), 3-aminopropyltrimethoxysilane (DYNASYLAN® AMMO), N-2-aminoethyl-3-aminopropyltrimethoxysilane (DYNASYLAN® DAMO), N-(2-aminoethyl)-3-aminopropyltrimethoxysilane (DYNASYLAN® DAMO-T) and a triamino-functional propyltrimethoxysilane (called DYNASYLAN® TRIAMO).

When reacting the epoxy resins with the amine-terminated polyether, an excess of epoxy groups over the amino groups is preferably used so that the latter react completely with epoxide groups. Typically, there is a 1.5 to 10-fold excess, for example a 3.5-fold excess of epoxy groups over the active hydrogen equivalents (AHEW) of the amine-terminated polyether. In preparing the composition according to the present invention, the epoxy-based prepolymer component preferably is initially prepared in a first stage. To this end, preferably, the epoxy resins are reacted with the amine-terminated polyether c) in the desired ratio. The reaction preferably is carried out at high temperature, preferably at 90 to 130° C., for example at approximately 120° C., for a period of time of, e.g., three hours.

Other tougheners or impact modifiers known in the epoxy adhesive art may be used in addition to, or as a substitute for, the aforementioned epoxy-based prepolymers derived by reaction of amine-terminated polyethers with epoxy resins. Generally speaking, such tougheners and impact modifiers are characterized by having glass transition temperatures below about 0° C., preferably below about −30° C., even more preferably below about −50° C. Examples of such tougheners and impact modifiers include, but are not limited to:

reaction products of epoxy-reactive copolymers of conjugated dienes such as butadiene (especially epoxy-reactive copolymers of butadiene with relatively polar comonomers such as (meth)acrylonitrile, (meth)acrylic acid, or alkyl acrylates, e.g., carboxyl-terminated butadiene-nitrile rubbers, such as the products available commercially from Noveon under the trade name HYCAR) with epoxy resins (as described, for example, in U.S. Patent Application Publication Nos. US 2003/0196753 and US 2005/0070634 and U.S. Pat. No. 6,776,869, each of which is incorporated herein by reference in its entirety);
adducts of anhydrides (e.g., unsaturated anhydrides such as maleic anhydride) and diene polymers (e.g., liquid 1,4-cis polybutadienes), typically having number average molecular weights between about 1000 and about 5000, including for example, the adducts sold under the tradename POLYVEST by Degussa Corporation, as well as further reaction products of such adducts with epoxy resins;
polyesters, including, for example, amorphous, crystalline and/or semi-crystalline polyesters, including saturated polyesters, prepared by condensation of aliphatic and/or aromatic dicarboxylic acids (or the corresponding alkyl esters or anhydrides with diols having a chain length of C₂ to C₂₀, the polyesters being of medium molecular weight (e.g., about 1000 to about 20,000 number average molecular weight), such as the polyesters sold under the tradename DYNACOLL by Degussa Corporation, and including polyesters functionalized with carboxylic acid and/or hydroxyl endgroups, as well as adducts of such functionalized polyesters with epoxy resins;
adducts of dimeric fatty acids with epoxy resins (including, for example, the adducts sold under the tradename EPON 872 by Resolution Performance Products, the adducts sold under the tradename HYPDX DA323 (formerly ERISYS EMDA 3-23) by CVC Specialty Chemicals, as well as those adducts described in U.S. Pat. No. 5,218,063, incorporated herein by reference in its entirety);
adducts of hydroxyl-containing triglycerides (e.g., castor oil) with epoxy resins (including, for example, the adducts sold under the tradename HELOXY 505 by Resolution Performance Products);
adducts of polysulfides with epoxy resins (including, for example, the adducts sold under the tradename THIOPLAST EPS 350 by Akzo Nobel;
adducts of amine-terminated polydienes and diene copolymers with epoxy resins;
polyether prepolymers capped with hydroxyarylcarboxylic or hydroxyaralkylcarboxylic acids, or a capped polyester, polythioester or polyamide containing polyether segments, as described, for example, in U.S. Pat. No. 5,202,390, incorporated herein by reference in its entirety, in particular the tougheners of formula I described in detail at column 1, line 59, to column 2, line 16, of said patent;
block copolymers, wherein at least one polymeric block of the copolymer has a glass transition temperature below 20° C. (preferably below 0° C. or below −30° C. or below −50° C.) and at least one polymeric block of the copolymer has a glass transition temperature above 20° C. (preferably above 50° C. or above 70° C.), in particular block copolymers containing a polystyrene block, a 1,4-polybutadiene block (preferably having a glass transition temperature below about −60 degrees C.) and a polymethylmethacrylate block (preferably, having a highly, i.e., >80%, syndiotactic structure), such as the SBM copolymers made by living polymerization methods using nitroxide initiator (such as the methods described in U.S. Pat. Nos. 5,677,387, 5,686,534, and 5,886,112, each of which is incorporated herein by reference in its entirety, and sold under the tradename NANOSTRENGTH by Arkema and the block copolymers described in U.S. Pat. No. 6,894,113, incorporated herein by reference in its entirety;
carboxyl-functionalized adducts of amino- or hydroxyl-terminated polymers and carboxylic anhydrides, as well as further reaction products of such adducts with epoxy resins (such as those described in U.S. Pat. No. 6,884,854 and U.S. Patent Application Publication No. 2005/0215730, each of which is incorporated herein by reference in its entirety);
epoxy-terminated polyethers, such as polymers of alkylene oxides like ethylene oxide, propylene oxide or mixtures thereof that have been functionalized with epoxy groups, including by reacting the hydroxy groups of a polyalkylene glycol with epichlorohydrin;
phenol-terminated and aminophenyl-terminated products produced by reacting a stoichiometric excess of a carboxylic anhydride or dianhydride with a diamine or polyamine and then further reacting the excess carboxylic anhydride or carboxylic acid groups with at least one polyphenol or aminophenol, as described, for example, in U.S. Patent Application Publication No. 2004/0181013, incorporated herein by reference in its entirety.

Mixtures of different auxiliary impact modifiers/toughening agents may be used. The total amount of auxiliary impact modifier/toughening agent in the curable compositions of the present invention may vary substantially but typically is up to about 40 weight percent, e.g., from about 5 to about 25 weight percent.

When an epoxy-based prepolymer is used, the composition typically may contain from about 5 to about 30 weight percent (in one embodiment, from about 10 to about 25 weight percent) of such epoxy-based prepolymer.

### Curing Agents

Since the compositions of the present invention are preferably one-part compositions and are to be cured at elevated temperature, they also contain one or more curing agents (hardeners) capable of accomplishing cross-linking or curing of certain of the adhesive components when the adhesive is heated to a temperature well in excess of room temperature. That is, the hardener is activated by heating. The hardener may function in a catalytic manner or, in preferred embodiments of the invention, participate directly in the curing process by reaction with one or more of the adhesive components.

There may be used as thermally-activatable or latent hardeners for the adhesive compositions of the present invention, for example, guanidines, substituted guanidines, substituted ureas, melamine resins, guanamine derivatives, cyclic tertiary amines, aromatic amines and/or mixtures thereof. The hardeners may be involved stoichiometrically in the hardening reaction; they may, however, also be catalytically active. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide). Representatives of suitable guanamine derivatives which may be mentioned are alkylated benzoguanamine resins, benzoguanamine resins or methoxymethylethoxymethylbenzoguanamine. For single-component, thermosetting adhesives, the selection criterion is, of course, the low solubility of those substances at room temperature in the resin system, so that solid, finely ground hardeners are preferred; dicyandiamide is especially suitable. Good storage stability of the composition is thereby ensured.

In addition to or instead of the above-mentioned hardeners, catalytically-active substituted ureas may be used, such as p-chlorophenyl-N,N-dimethylurea (monuron), 3-phenyl-1,1-dimethylurea (fenuron) or 3,4-dichlorophenyl-N,N-dimethylurea (diuron). In principle, catalytically active tertiary acryl- or alkyl-amines, such as benzyldimethylamine, tris(dimethylamino)phenol, piperidine or piperidine derivatives, may also be used, but they are in many cases too highly soluble in the adhesive system, so that usable storage stability of the single-component system is not achieved. Various imidazole derivatives, preferably solid imidazole derivatives, may also be used as catalytically-active accelerators. Examples which may be mentioned are 2-ethyl-2-methylimidazole, N-butylimidazole, benzimidazole and N—C₁ to C₁₂-alkylimidazoles or N-arylimidazoles. Particular preference is given to the use of a combination of hardener and accelerator in the form of so-called accelerated dicyandiamides in finely ground form. The separate addition of catalytically-active accelerators to the epoxy hardening system is thus not necessary.

The amount of curing agent utilized will depend upon a number of factors, including whether the curing agent acts as a catalyst or participates directly in crosslinking of the composition, the concentration of epoxy groups and other reactive groups in the composition, the desired curing rate and so forth. Typically, the composition contains from about 0.5 to about B weight percent curing agent(s).

### Diluent

Optionally, a diluent may be used together with the incentive compositions. The diluent may be reactive or non-reactive. In the reactive sense, the diluent should possess functionality appropriate to react with the epoxy resin and/or other components in the inventive composition. In the non-reactive sense, the non-reactive diluent may affect the flexibility of the cured product of the inventive composition and/or be used to improve the mixability of the components of the composition and/or the composition itself.

Suitable reactive diluents include monofunctional epoxy resins. The monofunctional epoxy resin should have an epoxy group with an alkyl group of about 6 to about 28 carbon atoms, examples of which include C₅-C₂₈ alkyl glycidyl ethers, C₆-C₂₈ fatty acid glycidyl esters and C₆-C₂₈ alkylphenol glycidyl ethers.

Additional reactive diluents include those having (meth)acrylate and/or vinyl ether functionality. In some embodiments that include a reactive diluent, the reactive diluent is a “hybrid” diluent because it includes at least one vinyl ether or 1-alkenyl ether group and at least one (meth)acrylate group. For instance, the reactive diluent may be represented by the following formula (A):

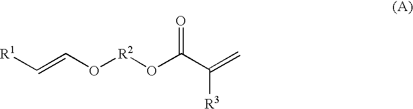

where R¹ is selected from hydrogen; aliphatic C₁₋₆ alkyl; and C₁₋₆ cycloalkyl;

R² is selected from C₂₋₂₀ alkylene; C₂₋₂₀ hydrocarbon diradical; and polyalkylene oxide; and

R³ is selected from hydrogen and methyl.

Here, the reactive diluent may have a molecular weight of less than about 1500. Desirably, the molecular weight is less than about 750, more desirably less than about 500. The viscosity of the reactive diluent may be less than about 5000 cps at 25° C., more desirably less than about 2000 cps and even more desirably about 50-500 cps.

Examples of suitable reactive diluents include, but are not limited to 2-(2′-vinyloxyethoxy)ethyl acrylate, 2-(2′-vinyloxyethoxy)ethyl methacrylate, 2-vinyloxyethyl acrylate, 2-vinyloxyethyl methacrylate, 2-(2′-prop-1-enyloxyethoxy)ethyl methacrylate, 2-(2′-prop-1-enyloxyethoxy)ethyl acrylate, and combinations thereof.

Additional reactive diluents include for instance hydroxyethyl methacrylate, hydroxypropyl methacrylate, dimethyl acrylamide and isobornyl acrylate, to name but a few.

Suitable non-reactive diluents for use in the present invention include, for example, sulfonate diluents, phosphate ester diluents, sulfonamide diluents, glycerin triester diluents, dialkyl esters of aliphatic dicarboxylic acids, glycol esters of benzoic acid and the like. Preferably, the diluent is not a phthalate-containing diluent.

Illustrative sulfonate diluents include alkyl sulfonic acid esters of phenolic compounds such as the phenyl cresyl esters of pentadecyl sulfonic acid. Suitable commercially available sulfonate diluents include the diluent sold by Bayer under the tradename MESAMOLL.

Phosphate ester diluents include the organic esters of phosphoric acid, such as, for example, phenolic esters of phosphoric acid, e.g., tricresyl phosphate, cresyl diphenyl phosphate, isopropylated triphenyl phosphate, 2-ethylhexyl diphenyl phosphate, isodecyl diphenyl phosphate, and triphenyl phosphate, as well as other triaryl phosphates and alkyl diaryl phosphates. Other suitable phosphate diluents include, but are not limited to, tributoxyethyl phosphate, tributyl phosphate, and the like.

Suitable glycerin triester diluents include the compounds described in U.S. Pat. No. 6,652,774, incorporated herein by reference in its entirety.

Sulfonamide diluents may also be utilized, including, for example, aromatic sulfonamides such as N-(2-hydroxypropyl) benzene sulfonamide (sold under the tradename UNIPLEX 225 by Unitex Chemical Co.), N-ethyl toluene sulfonamides, N-(n-butyl) benzene sulfonamide, N-cyclohexyl-p-toluenesulfonamide, and the like.

Other diluents suitable for use in the present invention include C₃-C₂₀ dialkyl esters of aliphatic dicarboxylic acids such as adipic acid, e.g., dioctyl adipate, dibutyl adipate, di(2-ethylhexyl) adipate, diisononyl adipate, diisodecyl adipate, and di(heptyl, nonyl) adipate as well as glycol esters of benzoic acid such as dipropylene glycol dibenzoate and dipropylene glycol monobenzoate.

The adhesive compositions of the present invention may contain, for example, up to about 20 weight percent total of diluent (e.g., about 0.1 to 10 or about 1 to about 8 weight percent).

In embodiments of the invention where a diluent is present, the weight ratio of the diluent to additive or auxiliary impact modifier/toughening agent (such as a polyurethane) is typically from about 0.1:1 to about 10:1 or, in other embodiments, from about 0.3:1 to about 3:1.

In certain embodiments of the invention, the auxiliary impact modifier/toughening agent selected for use may itself be a diluent and thus have flexibilizing properties. For example, where the additive or auxiliary impact modifier/toughening agent is a polyurethane sold under the tradename DESMOCAP 2540 (which is described as a linear prepolymer based on TDI and polyalkylene glycol prepared using double metal cyanide catalysts, with the isocyanate groups being blocked) by Bayer Material Science could be suitable for such purposes.

### Adhesion Promoters

To help improve adhesion of the cured adhesive to a substrate surface, especially a metallic substrate surface contaminated with oily substances as is commonly encountered in vehicle assembly operations, one or more reaction products of epoxy resins and compounds containing chelating functional groups (herein called “chelate-modified epoxy resins”) are added to the composition.

Such reaction products include those substances commonly referred to in the art as “chelate epoxies” or “chelating epoxy resins”. The chelating functional groups include those functional groups capable of forming chelate bonds with divalent or polyvalent metal atoms, either by themselves or in cooperation with other functional groups positioned on the same molecule. Suitable chelating functional groups include, for example, phosphorus-containing acid groups (e.g., —PO(OH)₂), carboxylic acid groups (—CO₂H), sulfur-containing acid groups (e.g., —SO₃H), amino groups, and hydroxyl groups (particularly hydroxyl groups adjacent to each other on aromatic rings). The preparation of such reaction products may be carried out by methods known in the art such as, for example, those methods described in U.S. Pat. Nos. 4,702,962 and 4,340,716, European Patent No. EP 342 035 and Japanese Patent Document Nos. JP 58-063758 and JP 58-069265, each of which is incorporated herein by reference in its entirety. Reaction products of epoxy resins and compounds containing chelating functional groups are also available from commercial sources such as, for example, the ADEKA Resins EP-49-10N, EP-49-55C, EP-49-10, EP-49-20, EP-49-23, and EP-49-25 sold by Asahi Denka. Typically, the composition may contain up to about 8 weight percent (e.g., from about 0.1 to about 3 weight percent) of such chelate-modified epoxy resins.

Other compounds having metal chelating properties may also be used in the compositions of the present invention to help enhance the adhesion of the cured adhesive to a substrate surface, including, for example, the adhesion promoters described in U.S. Patent Application Publication No. US 2005/0129955, incorporated herein by reference in its entirety. Also suitable for use as adhesion promoters are the acetoacetate-functionalized modifying resins sold by King Industries under the brand name K-FLEX XM-B301.

### Other Additives

The inventive compositions may, in addition to the aforementioned platy fillers, also contain known fillers such as the various ground or precipitated chalks, quartz powder, alumina, non-platy clays, dolomite, carbon fibers, glass fibers, polymeric fibers, titanium dioxide, fused silica, carbon black, calcium oxide, calcium magnesium carbonates, barite and, especially, silicate-like fillers of the aluminum magnesium calcium silicate type, for example wollastonite and chlorite. Typically, the compositions of the present invention may contain from about 0.5 to about 10 weight percent of fillers.

In one embodiment of the invention, the composition additionally contains one or more expanding agents (sometimes referred to in the art as blowing agents). The expandable properties of the resulting adhesive are particularly useful in applications where the complete filling of a gap or cavity in a part or member is critical in order to maintain maximum structural integrity of the part or member. The foamed cured adhesive has improved fracture toughness, thereby imparting impact resistance to the assembly. If the composition is to be utilized as a one-part or single-component composition, the expanding agent is preferably a latent expanding agent which causes expansion or foaming of the adhesive only when heated to a temperature significantly above room temperature (typically, a temperature which is in the range at which curing of the adhesive is also initiated). Although any suitable expanding agent may be employed, such as a chemical expanding agent, e.g., azo compounds, hydrazides and the like, particular preference is given to expandable microspheres. Expandable microspheres generally comprise small diameter polymeric shells or bubbles which encapsulate one or more volatile substances such as light hydrocarbons or halocarbons. The outer shells are usually thermoplastic in character to permit softening and expansion of the microspheres when heated due to volatilization of the substances trapped within the shells. The polymers used in the shells may be linear, branched, or cross-linked and may be comprised of, for example, acrylic resins, styrenic resins, polyvinylidene chloride, nitrile polymers, and the like. Typically, the average particle size of the expandable microspheres is in the range of from about 5 to about 100 microns. Suitable expandable microspheres are commercially available under the tradenames DUALITE and EXPANCEL from Henkel Corporation and Casco Nobel, respectively.

In yet another embodiment, hollow glass microspheres are present in the composition. Commercially available hollow glass microspheres include the materials sold by Minnesota Mining & Manufacturing under the trademark SCOTCHLITE, with suitable grades including those available under the designations B38, C15, K20 and VS 5500. The glass microspheres preferably have diameters in the range of from about 5 to 200μ and/or densities of from about 0.3 to about 0.5 g/cc. Typically, the composition may contain from about 0.5 to about 5 weight percent of hollow glass microspheres.

The adhesive compositions according to the present invention may also contain other common adjuvants and additives, such as diluents, reactive and/or non-reactive diluents, flow auxiliaries, coupling agents (e.g., silanes), adhesion promoters, wetting agents, tackifiers, flame retardants, thixotropic and/or rheology control agents, ageing and/or corrosion inhibitors, stabilizers and/or coloring pigments. Depending on the requirements made of the adhesive application with respect to its processing properties, its flexibility, the required rigidifying action and the adhesive bond to the substrates, the relative proportions of the individual components may vary within comparatively wide limits.

In one embodiment, the composition includes a reactive diluent such as a mono-epoxide (e.g., monoglycidyl ethers of alkyl- and alkenyl-substituted phenols). Typically, the composition contains up to about 10 weight percent (e.g., from about 0.1 to about 5 weight percent) reactive diluent.

### Methods of Use

The inventive composition is suitable for adhering together parts made of different materials, including, for example, wood, metal, coated or pretreated metal, plastic, filled plastic, thermoset materials such as sheet molding compound and fiberglass and the like. The substrates to be joined using the adhesive may be the same as or different from each other. It is preferably used for the gluing of metal parts and particularly for the gluing of steel sheets such as cold rolled steel sheets. These can also be electro-galvanized, hot-dip galvanized and/or zinc/nickel-coated steel sheets, for example. The composition is especially useful for bonding substrates having surfaces contaminated with oily substances, as good adhesion is attained despite such contamination.

The inventive composition can be applied to a substrate surface by any technique known in the art. For example, it can be applied by extrusion from a robot in bead form onto the substrate or by mechanical application methods such as a caulking gun, or any other manual application means, and can also be applied using a swirl or streaming technique. The swirl and streaming techniques utilize equipment well known in the art such as pumps, control systems, dosing gun assemblies, remote dosing devices and application guns. Generally, the adhesive is applied to one or both of the substrates to be joined. The substrates are contacted such that the adhesive is located between the substrates to be bonded together. Thereafter, the adhesive composition is subjected to heating to a temperature at which the heat curable or latent curing agent initiates cure of the epoxy resin composition.

In one embodiment, the adhesive is formulated so as to function as a hot melt; that is, an adhesive which is solid at room temperature, but capable of being converted to a pumpable or flowable material when heated to a temperature above room temperature. In another embodiment, the composition of this invention is formulated to be capable of being flowed or pumped to the work site at ambient temperatures or slightly above since, in most applications, it is preferable to ensure that the adhesive is heated only up to a temperature at which the latent curing agent is not yet activated. The melted composition may be applied directly to the substrate surface or may be allowed to flow into a space separately the substrates to be joined, such as in a hem flanging operation. In yet another embodiment, the composition is formulated (by inclusion of a finely divided thermoplastic or by use of multiple curatives having different activation temperatures, for example) such that the curing process proceeds in two or more stages (partial curing at a first temperature, complete curing at a second, higher temperature). The two parts are joined together, preferably immediately after deposition of the adhesive mass, thereby provisionally bonding the two parts to each other.

The resultant bond preferably already has sufficient strength so that the still uncured adhesive is not readily washed out, as might otherwise occur, for example, if the metal sheets which are provisionally bonded to each other are treated for de-greasing purposes in a wash bath and then in a phosphating bath.

The composition is preferably finally cured in an oven at a temperature which lies clearly above the temperature at which the composition was applied to the parts to be bonded and at or above the temperature at which the curing agent and/or accelerator and/or latent expanding agent (if present) are activated (i.e., in the case of the hardener, the minimum temperature at which the curing agent becomes reactive towards the other components of the adhesive; in the case of the expanding agent, the minimum temperature at which the expanding agent causes foaming or expansion of the adhesive). Curing preferably takes place at a temperature above 150° C., for example at 160 to 220° C., for a period of time of about 10 to about 120 minutes.

Once cured, the adhesive compositions according to the present invention may be used as casting resins in the electrical or electronics industry or as die attach adhesives in electronics for bonding components to printed circuit boards. Further possible applications for the compositions are as matrix materials for composites, such as fiber-reinforced composites. One particularly preferred application for the adhesives according to the present invention is the formation of structural bonds in vehicle construction such as in hem flanges and the like.

In the embodiment of the invention where the composition includes one or more expanding agents, the adhesive may be utilized to form structural foams which serve to stiffen and reinforce cavities, gaps, structural members and the like. The composition may be supported or contained within a carrier or receptacle or the like so as to position or orient the adhesive such that it expands in one or more particular directions when heated to induce curing and foaming. The composition thus is particularly useful in filling irregularly shaped spaces, as the composition will expand so as to come into contact with a greater portion of the substrate surfaces in the vicinity of the composition than would occur if no expanding agent was present. The foamed, cured composition stiffens and/or increases the energy absorption capacity of vehicle cavities and structural members.

What is claimed is:

1. A composition comprising:
A) at least one epoxy resin;
B) rubber particles characterized by the absence of a shell;
C) at least one auxiliary impact modifier/toughening agent; and
D) at least one heat-activated latent curing agent.

2. The composition of claim 1 wherein the epoxy resin is in the liquid state.

3. The composition of claim 1 wherein the epoxy resin is in the semi-solid state.

4. The composition of claim 1 wherein the rubber particles have an average particle size of less than 500 nm.

5. The composition of claim 1 wherein the rubber particles have an outer surface that has been modified to make said rubber particles capable of being more readily dispersed in said at least one epoxy resin.

6. The composition of claim 1 wherein the auxiliary impact modifier/toughening agent is a member selected from the group consisting of a polyurethane, an epoxy/JEFFAMINE adduct, and combinations thereof.

7. A composition comprising:
A) at least one epoxy resin;
B) rubber particles;
C) at least one additive selected from the group consisting of polyurethanes, platy fillers, and anti-oxidants; and
D) at least one heat-activated latent curing agent.

8. The composition of claim 7 wherein said rubber particles have an average particle size of less than 500 nm.

9. The composition of claim 7 wherein at least a portion of the rubber particles are provided to the adhesive composition in the form of a stable dispersion in an epoxy resin.

10. The composition of claim 7 additionally comprising at least one auxiliary impact modifier/toughening agent.

11. The composition of claim 7 additionally comprising at least one epoxy-based prepolymer obtained by reacting one or more amine-terminated polymers with one or more epoxy resins.

12. The composition of claim 1 additionally comprising at least one chelate-modified epoxy resin.

13. The composition of claim 7 additionally comprising at least one chelate-modified epoxy resin.

14. The composition of claim 1 wherein said rubber particles are comprised of a diene homopolymer, diene copolymer or polysiloxane elastomer.

15. The composition of claim 7 wherein said rubber particles are comprised of a diene homopolymer, diene copolymer or polysiloxane elastomer.

16. The composition of claim 1 wherein said rubber particles have an average particle size of less than about 250 nm.

17. The composition of claim 7 wherein said rubber particles have an average particle size of less than about 250 nm.

18. The composition of claim 1 further comprising a diluent selected from the group consisting of reactive diluent and non-reactive diluent.

19. The composition of claim 7 further comprising a diluent selected from the group consisting of reactive diluent and non-reactive diluent.

20. The composition of claim 18 wherein said diluent is selected from the group consisting of phosphate ester diluents and sulfonate diluents.

21. The composition of claim 19 wherein said diluent is selected from the group consisting of phosphate ester diluents and sulfonate diluents.

22. A method of making a composite article which comprises: contacting a surface with the composition of claim 1 and curing the composition in contact with the surface to prepare a composite article.

23. The method of claim 22 in which the surface is metal.
